(19) United States
(12) Patent Application Publication
(10) Pub. No.: US 2016/0244268 A1
(43) Pub. Date: Aug. 25, 2016

(54) MOBILE MATERIAL ELEVATING SYSTEM

(71) Applicant: Vita International, Inc., Houston, TX (US)

(72) Inventor: Alexander F. Ritter, Huffman, TX (US)

(21) Appl. No.: 14/833,298

(22) Filed: Aug. 24, 2015

Related U.S. Application Data
(60) Provisional application No. 62/118,428, filed on Feb. 19, 2015.

(51) Int. Cl. B65G 41/00; B65G 43/00; B60B 35/00; B65G 47/34; B62D 33/08; B65G 17/12; B65G 47/16

(52) U.S. Cl. CPC B65G 41/002; B65G 17/126; B65G 43/00; B65G 47/16; B65G 47/34; B62D 33/08; B60B 35/00

(57) ABSTRACT

Apparatus for elevating materials that is particularly useful in limited spaces and/or where flexibility in positioning is desirable. Fully self-contained, the apparatus is trailer mounted and provided with a hydraulic system for positioning and powering the individual components as needed to feed material from supply trucks to the apparatus and then to vertically elevate the material for distribution to desired locations as needed for such purposes as, for instance, delivering proppant to site storage for hydraulic fracturing of oil wells. The individual components, including a material-receiving feeder pan, inclined auger, rotatable tower mount, and bucket elevator are preferably trailer-mounted and the bucket elevator is selectively positionable from a first, position for operating and elevating materials to a second position for over-the-road transport.

This application claims the benefit of U.S. provisional application No. 62/118,428, filed Feb. 19, 2015. Application No. 62/118,428 is hereby incorporated into this application in its entirety by this specific reference thereto.

### BACKGROUND OF THE INVENTION

Oftentimes bulk materials delivered to jobsites need to be elevated to allow them to be used, delivered to transport, or stored. At elevation, bulk materials are typically routed to chutes or spouts which guide them to silos or other storage; conveyors, augers, or other means of moving the material; or into trailers, trucks, railcars, or other transport vehicles. As jobsite locations can vary, the means for elevating materials must be mobile and able to be set up as needed. Typical methods for elevating bulk materials via mobile material elevators utilize belt conveyors or pneumatic delivery. Downsides to these methods are that conveyors take up a lot of room on a site due to their length and limited incline during operation, whereas pneumatic conveyance is slow and creates significant airborne dust of the material being delivered. Additionally, pneumatic delivery can degrade the material being delivered by breaking the material as the material impacts itself and/or the structure into which it is being delivered.

This invention is different than any prior art in that it addresses the shortcomings of other portable means of elevating materials by utilizing a vertical-standing bucket elevator for conveyance, though other designs such as augers or specialized vertical belt conveyors may be used as well. The uniqueness of this invention is that it makes portable a method of elevating material that is normally a fixed, permanent means of conveyance. The invention is a fully self-contained means of receiving bulk material at a low feeding height typical of truck or railcar hopper delivery, and elevating the material to a height needed for using the material, be it in the oilfield, construction, mining, agriculture, or other fields. At elevation, materials being elevated are directed through a distributor to desired points. The invention utilizes a unit-mounted self-feeder system that swings through an arc of approximately 270 degrees, giving flexibility in positioning so that the unit is not required to be set up in a specific singular manner. Additionally, the feeder is of low profile, allowing the invention to be used with many types of transports that deliver material to the invention for elevation. The capacity of the invention is high, 100+ tons per hour with sand as an example material. Furthermore, because the material is conveyed upward in a bucket where the grains are at rest in relation to each other, and at discharge fall by gravity without being impacted against a solid object at high velocity, the conveyed material is less likely to be damaged by the conveyance process, keeping fines generation to a minimum.

Oilfield hydraulic fracturing is a perfect scenario for use of the present invention, as huge quantities of silica sand are used. The sand is typically pneumatically delivered, but pneumatic delivery releases large quantities of respirable silica dust which, on information and belief, is in the process of being regulated by OSHA to decrease the exposure and subsequent detrimental effects on workers exposed to sand operations at well sites. It is not uncommon for 4 to 6 sand transports to be unloading at one time at frac sites, releasing approximately 1000 cfm per unit of air with silica sand fines for up to 1½ hours for each load of sand delivered to the site. The present invention eliminates the liberation of this high volume of air with silica that is generated by pneumatic delivery. As well, when pneumatically delivered, because the silica sand is blown against the interior plates of the sand trailers commonly used in the industry, it is fractured by impact releasing more fines, with fines being less desirable for frac operations. The present invention reduces the damage to the sand and keeps fines to a minimum with the result being improved frac performance as well as dust mitigation. Additionally, this invention is compatible with the many different and numerous sand storage and distribution units currently built and employed in the fracturing industry, allowing service companies to continue to use equipment they have already paid for without having to replace that existing equipment, providing a substantial economic benefit to the companies.

Other objects, and the many advantages of the present invention, will be made clear to those skilled in the art in the following detailed description of the preferred embodiment(s) of the invention and the drawing(s) appended hereto. Those skilled in the art will recognize, however, that the embodiment(s) of the present invention that are described herein are only examples of specific embodiment(s), set out for the purpose of describing the making and using of the present invention, and that the embodiment(s) shown and/or described herein are not the only embodiment(s) of an apparatus and/or method constructed and/or performed in accordance with the teachings of the present invention. Further, although described herein as having particular application to certain oilfield operations, as noted above, those skilled in the art who have the benefit of this disclosure will recognize that the present invention may be utilized to advantage in many other applications in which large quantities of bulk materials must be elevated, the present invention being described with reference to the oilfield for the purpose of exemplifying the invention, and not with the intention of limiting its scope.

### SUMMARY OF THE INVENTION

The present invention meets the above-described functions and objectives by providing, in a first embodiment, a bucket elevator trailer comprising a trailer with frame, axles, and wheels, and further comprising a vertical bucket elevator pivotally mounted to the trailer frame; a hydraulic cylinder lift system used to raise the elevator to a first, vertical position and lower the elevator to a second, road-transportable height; hydraulic operated stabilizers, which are preferably gyroscopically controlled, which level the unit assuring true vertical positioning of the elevator; a trailer mounted self-feeder assembly with a hydraulically driven inclined auger; a low-profile under-transport feeder pan hydraulically driven to feed the inclined auger; a rotatable tower mount assembly to which the inclined auger/under transport feeder pan assemblies are attached; a flow path for the material being moved from the top of the inclined auger, into the inside of the tower assembly through the interior of the rotating mount joint, to a chute feeding into the vertical elevator; a hydraulic extension chute which retracts when the elevator is in the second, transport position; a swivel joint between the inclined unit feeder auger and tower assembly through which the material passes; hydraulic cylinders for vertical movement of the inclined auger and the under-transport feeder; a hydraulic rotating mechanism which causes the self-feeder tower assembly to rotate to a first operating position and to stow the assembly in the second position for transport; a distributor mounted to the discharge of the bucket elevator which directs the elevated material into selected spouts which in turn direct the material to desired locations; an engine-driven hydraulic system to provide power to position the elevator, power the elevator, power the self-feeder assembly positioning system, power the self-feeder, power the leveling system, and provide power for other required functions; further comprising the trailer to which the system is mounted and that is provided with racks and holders to transport spouting, pipes, and hoses which convey the material being elevated to a final disposition point. Drag conveyors, belts, and augers are used to further distribute the material which has been elevated to final needed positions.

In a variation of the invention, the bucket elevator discharges at a height where the material vertically conveyed drops after discharge into a single spout or mechanical conveyance (drag chain/auger/belt) leading to a remote distributor, which in turn has multiple spouts attached to fill multiple storage compartments or material use points. This variation uses gravity to distribute the materials being conveyed by the invention to multiple use points rather than a drag chain/auger/other distribution means. The basic invention (portable bucket elevator with self-feeder) remains the same as described earlier and the only change is the discharge equipment and material distribution method.

One variation of the invention described herein is that the truck tractor used to transport the material elevator may be provided with a hydraulic pump system and be connected to the material elevator, negating the need for a motor-driven hydraulic system mounted to the trailer. In this variation, all other facets of the invention remain the same, just the hydraulic source is external rather than on-board.

In another variation of the invention, the transport trailer is built to be significantly shortened at the operational location by uncoupling that part of the trailer ahead of the forward stabilizers and moving the front, or uncoupled, part of the trailer to a staging area away from where the elevating system is being used. This feature may be desired on operating sites which have a limited amount of area for parking the trailer to which the invention is mounted. In one embodiment, the detaching trailer portion is provided with a lift axle which is normally raised, but which is lowered for the trailer size reduction operation, allowing the truck which delivered the unit to remove that part of the trailer described without having to employ any additional equipment to perform this function. There are various arts that can be used to effect trailer separation, but in one embodiment that is new to the industry, this invention uses a trailer frame-wide pilot pin assembly on one half of the trailer which fits into a guide receptacle on the other half of the trailer, making it possible to quickly line up the trailer halves without exact alignment needed when making the connection. The trailer halves are held together using a hydraulic cylinder-positioned clamp which surrounds the mating flanges of the trailer halves on three sides; additionally, hydraulic cylinder actuated locking lugs hold the last flanged side together.

### BRIEF DESCRIPTION OF THE DRAWINGS

FIG. 1—Side view of a first embodiment of the invention when positioned in the down/transportation mode, showing the bucket elevator down, with unit feeder auger stowed on the trailer forward of passenger side tires, and the self-contained engine and hydraulic power pack on the driver's side.

FIG. 2—Side view of the embodiment of the invention shown in FIG. 1 in the erected/operating mode and showing the bucket elevator in first vertical position, with self-feeder assembly shown swung toward the rear of the unit and in operating position on the ground. As stated herein, a preferred application for the mobile material elevator of the present invention is in fracking operations, and for that reason, frac sand trailers are shown in background of this figure for reference.

FIG. 3—End view of the embodiment of the invention shown in FIG. 1 in the erected/operating mode with the bucket elevator in vertical position and the unit feeder auger shown swung to the opposite side of the unit and in operating position on the ground. This view shows the invention parked next to frac sand trailers and spouting from the invention distributor to the sand trailers.

FIG. 4—This is a view of the self-feeder of the invention, which is used to receive the material to be elevated from transport and elevate the material to feed into the bucket elevator; the self-feeder uses a screw conveyor or other means to elevate material at a steep angle.

FIG. 5—Top view of the self-feeder of the invention showing the top of the feeder pan with augers that pull the material from the dump point and feed it to the inclined portion of the feeder.

FIG. 6—Cross sectional view of feeder pan of self-feeder auger system showing position of pan augers.

FIG. 7—Top view of self-feeder auger and feeder pan, showing detail of pan augers and drives.

FIG. 8—Details of the cross-over where the material is transitioned from the inclined feeder auger to the center of the feeder mount, from where the material feeds the elevator.

FIG. 9—Side view of self-feeder elevating auger and feeder pan connection with feeder pan positioning hydraulic cylinder.

FIG. 10—Detail of the self-feeder at the inlet to the vertical elevator.

FIG. 11—Cross sectional view of the bucket elevator of the material elevating system of the present invention showing internal details of operating components.

FIG. 12—End view of feeder auger and feeder pan in position underneath a sand delivery trailer.

FIG. 13—Top view of the self-feeder showing the feeder pan arc underneath a sand trailer delivering sand to illustrate why the rotation aspect of the invention is important as a truck does not need to move position to unload the entire trailer.

FIG. 14—Top view of the material elevator of the present invention set up next to a series of frac sand storage trailers, showing the distributor, spouting leading to the top of the trailers, and material drag conveyors to deliver the material to the different bins of the trailers.

FIG. 15—View of the spread axle configuration of the trailer on which the material elevator of the present invention is mounted showing the base of the elevator mounted between rear-most axles.

FIG. 16—View of the material elevator of the present invention erected at a work site with the truck and forward portion on the main trailer frame disconnected for movement off location to decrease the site footprint of the material elevator during use.

FIG. 17—View of the trailer shortening connection point, showing the guide pin and clamps that hold the two parts of the trailer together when the trailer is full length

FIG. 18—Side view of the clamping method on the trailer connection point, detailing how the slide and pivoting clamps work to hold the trailer halves together.

FIG. 19—View showing a single discharge feeding to a remote mounted distributor which further sends material to other desired points via gravity.

FIG. 20—View showing a single discharge feeding a powered material conveyance, which feeds a remote mounted distributor which further sends material to other desired points via gravity.

### DETAILED DESCRIPTION OF THE PREFERRED EMBODIMENT(S)

Embodiments of the invention include a unit-mounted, mobile, self-erecting vertical conveyance (bucket elevator (4) in the embodiment shown, but because other systems such as an auger, chain conveyor, or specialty conveyor belts may be used, bucket elevator (4) is referred to herein as a “vertical conveyance” so as to include those, and other systems known in the art). The bucket elevator (4) of the present invention is an improvement over the prior art in that vertical bucket elevators are typically fixed in nature, mounted on concrete pads, and permanently erected by bolting and guying to adjacent structures or to stabilizing points around the elevator—they are not mobile. In addition, typical elevators are lightweight in their construction, as they are not required to self-erect. The bucket elevator (4) of the present invention embodies a pivot point (6) on the side of the elevator around which it rotates and is held in place, rather than a bolted-down base. The elevator (4) of the present invention is raised from its second, transport position to a first, vertical position by hydraulic cylinders (8), which attach to the main frame of the transport trailer (2) and also partway up the vertical leg of the conveyance (4). Due to the dynamic nature of the erection and laydown of the conveyance (4), the construction is substantially heavier than a typical fixed location conveyance and conveyance (4) is further reinforced to resist the forces exerted on it during erection and laydown which is a variance from prior art. As the vertical conveyance (4) is lengthy, it is imperative that it be erected truly vertical because if the inner components (described in detail below) are not vertical, they can rub on the internal walls of the main conveyance structure, wearing out both that structure and the internal movable conveyor components. To effect the vertical erection of the conveyance (4), hydraulic stabilizers (10) attached to the main frame of the unit are utilized; those skilled in the art will also recognized that other structure such as outriggers and jacks may also be used for this purpose and so as used herein, the term “stabilizers” is intended to refer to all such structure that is utilized for this purpose. These stabilizers (10) are controlled manually and/or automatically through electronic controls which utilize a gyroscopic or other types of tilt sensor system to determine true vertical. Alternatively, instrumentation showing vertical inclination and adjusting position-determining jacks, outriggers, or other mechanical means, or sensors are provided for monitoring and controls are operably connected to the stabilizers (10) and/or hydraulic cylinders for vertical conveyance (4) to maintain vertical conveyance (4) in the first, upright position. Because such sensors and controls are known in the art, they are not described in detail here. The stabilizers (10) additionally prevent movement of the unit relative to the ground it is installed on due to wind and/or during operation.

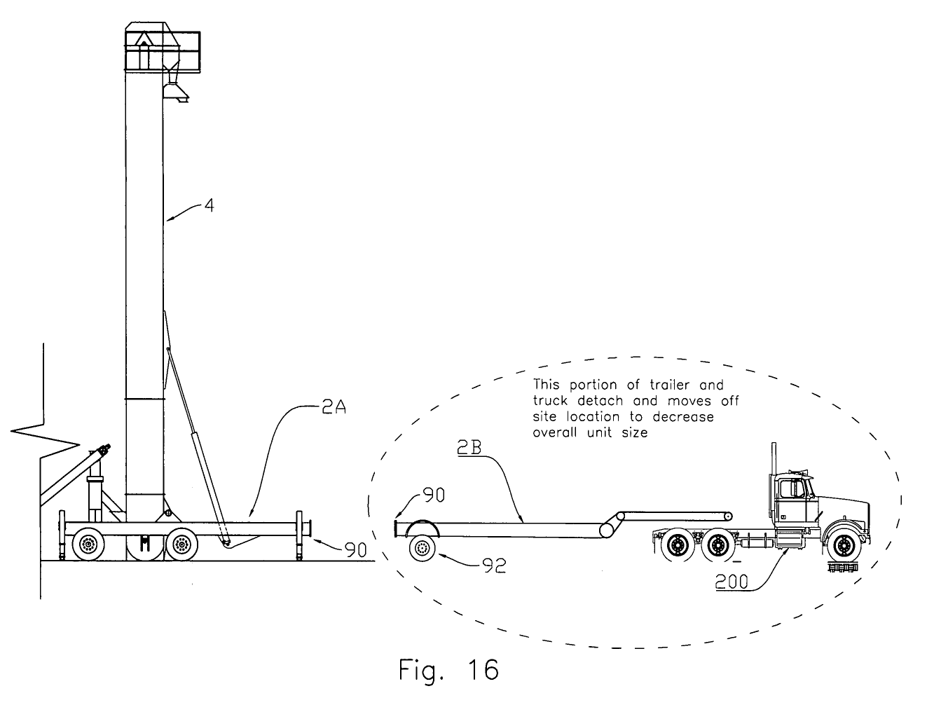

An embodiment of the invention is the main structure of the unit is a trailer (2) which is pulled by a truck tractor (200). Parts of the trailer (2) are the frame, running gear (suspension, axles, tires, and wheels), stabilizers, vertical conveyance lift cylinders and mounts, vertical conveyance mount and pivot, vertical conveyance transport cradle, self-feeder structural mounting, mounting for the self-contained hydraulic system and its components, and lift axle. The axles of the trailer specifically have a mounting spread (70) which allows the vertical conveyance (4) to be erected upright between the axles (see FIG. 15). The benefits of this spread axle (70) design include better weight distribution for transport, the rearmost axle serves as an under-ride guard for safety during road transportation, and over-all trailer length is built as short as possible without a long overhang behind the rear-most axle.

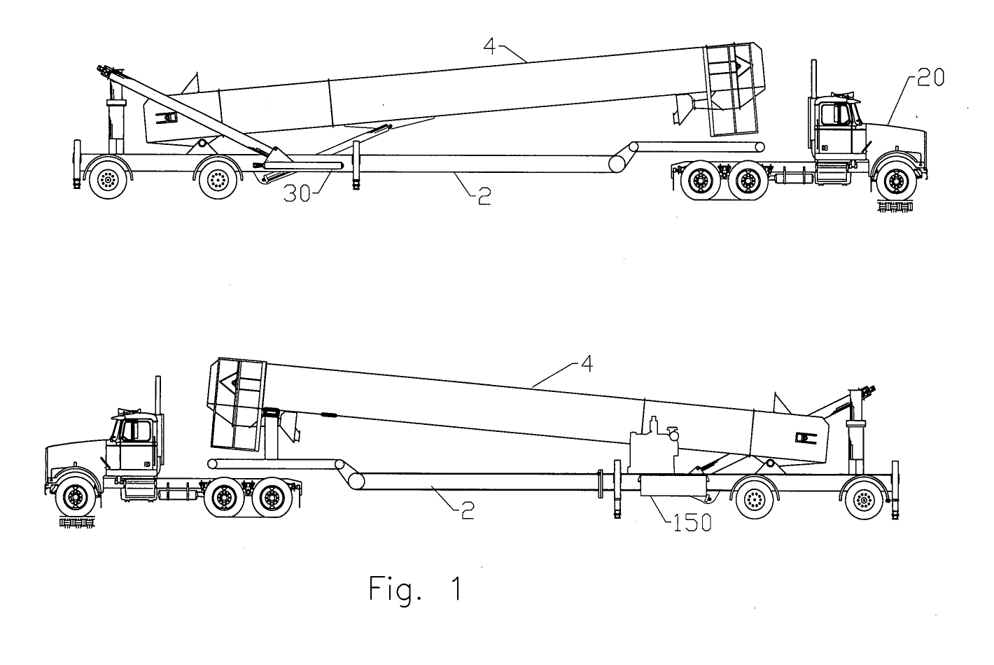

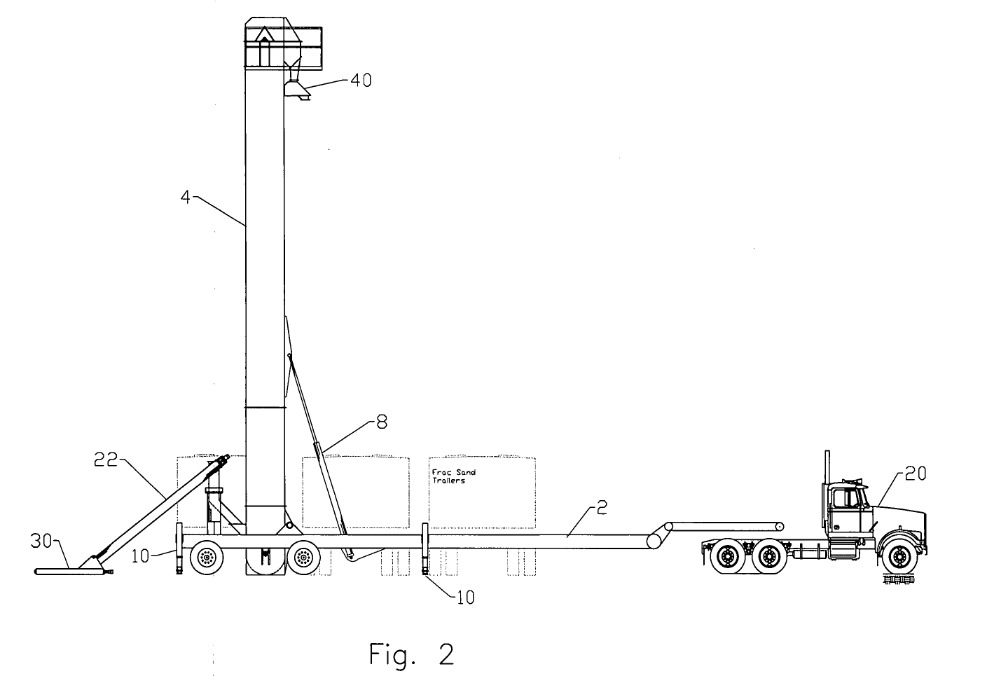

In the embodiment shown, the functions of the invention are operated with hydraulics. The unit has a self-contained hydraulic power unit (150) which consists of an engine which drives the hydraulic pump, the hydraulic pump and connecting couplers to the engine, a hydraulic tank with filtration, valves for controlling the functions of the systems, plumbing (hoses and pipes), motion control cylinders (main conveyance lift (8), feeder pan motion (38), elevating feeder auger lift (22), self-feeder rotation turntable drive system (20); drive systems for the vertical elevating conveyance, material elevating self-feeder conveyance (22); and the under-transport self-feeder pan (30) drive assembly. In the embodiment shown, the vertical conveyance (4) folds down from the first, vertical position shown in FIG. 2 to a second position (shown in FIG. 1) having a height which is transportable over roads without disassembly. Hydraulic cylinders (8) raise and lower the main vertical conveyance (4).

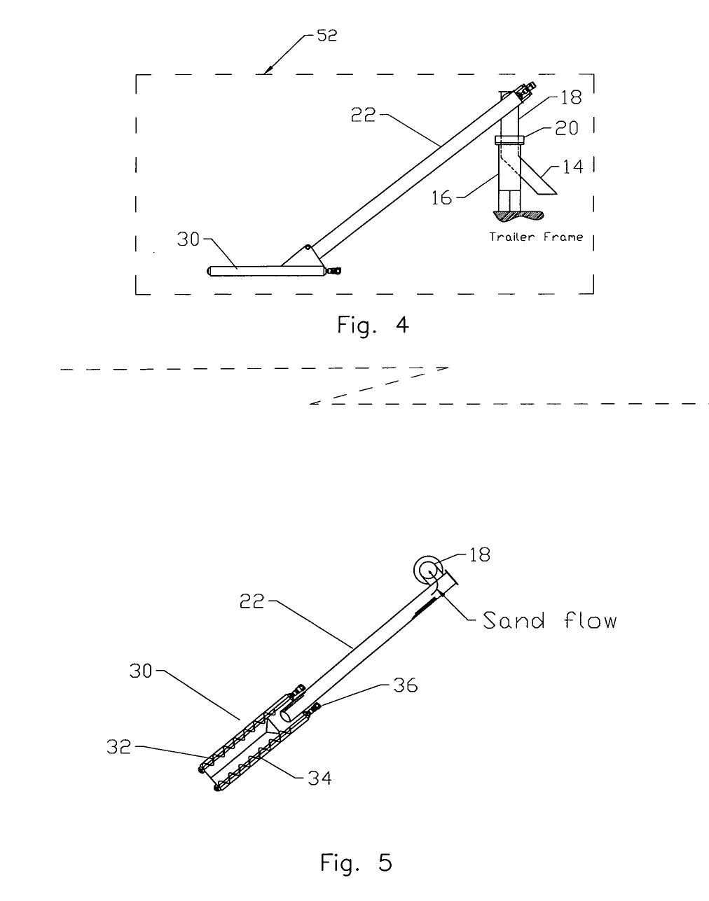

Another embodiment of the invention differing from prior art is the self-loading feeder (indicated generally at reference numeral (52) in FIG. 4) which is integral to the invention's main frame. Feeder (52) captures material being unloaded from transport (truck, trailer, rail car, etc) and moves the material to the inlet of vertical conveyance (4). Feeder (52) is horizontally and vertically movable, which allows it to be set onto the invention's main frame in a second position for transport, and to be moved to a first position underneath the discharge point of the delivering units' material outlets when in use. Uniquely, movement of feeder (52) is via on-board hydraulics so that an outside crane or lift mechanism is not required to position the feeder. The mounting structure for feeder (52) is built onto the main frame of trailer (2) and is fixed in place relative to vertical conveyance (4), but is built with a horizontally rotating joint (20) to which the feeder elevating conveyance (auger or belt system) mount structure attaches. Rotating joint (20) allows the feeder (52) to rotate horizontally more than 270 degrees, allowing flexible positioning of the unit when it is used. Self-feeder (52) comprises the main mounting structure (16) on trailer (2), the upper rotating structural assembly, or turret, (18) which is attached to a rotary bearing (20), the elevating auger assembly (22), the attaching swivel joint (24) connecting the elevating auger (22) to upper rotating assembly (18), a hydraulic cylinder and attaching structure (not numbered) which imparts vertical movement to the elevating auger (22), and a vertically-moveable feeder pan assembly (30) which consists of a low-profile structure with augers or a belting system to move material being handled from the delivering transport to the elevating auger (22). The feeder pan (30) is vertically rotatable around mount (110) by a hydraulic cylinder (38). The elevating auger (22) is attached to the upper rotating assembly/turret (18) by a swivel joint (24) which allows the auger to move vertically relative to its rotating structural mount assembly (18); the material being raised by the elevating auger (22) feeds from that auger into the upper rotating structural assembly/turret (18) and falls through the center of the upper rotating structural assembly (18) to a chute on the lower feeder mounting structure (16) which guides the material to the elevating conveyance inlet point (12). The chute (14) on the feeder mounting structure (16) is extendible (hydraulically or manually) which allows it to be moved out of the way when the main elevating conveyance (4) is laid down to the second position for road transport. Additional embodiments of this self-feeder system 52 may use other material elevating systems besides the auger (22) herein described such as high angle belt conveyors, paddle tube conveyors, or other systems which can elevate material at a steep angle and discharge to the rotating upper turret (18) and so the term “inclined conveyance” is used herein to refer to any such structure.

The feeder pan assembly (30) as embodied herein uses screw conveyors (32, 34) (also referred to herein as augers) to move the material from under the material-supplying transports to inclined conveyance (22). The augers (32, 34) rotate in a manner which at their discharge end allows the material being conveyed to be thrown into the inclined conveyance (22) inlet, which sits between the pan screw conveyors (32, 34).

Alternatively a belt feeder system is used in place of augers (32, 34). Hydraulic motors (36) power the pan screw conveyors (32, 34).

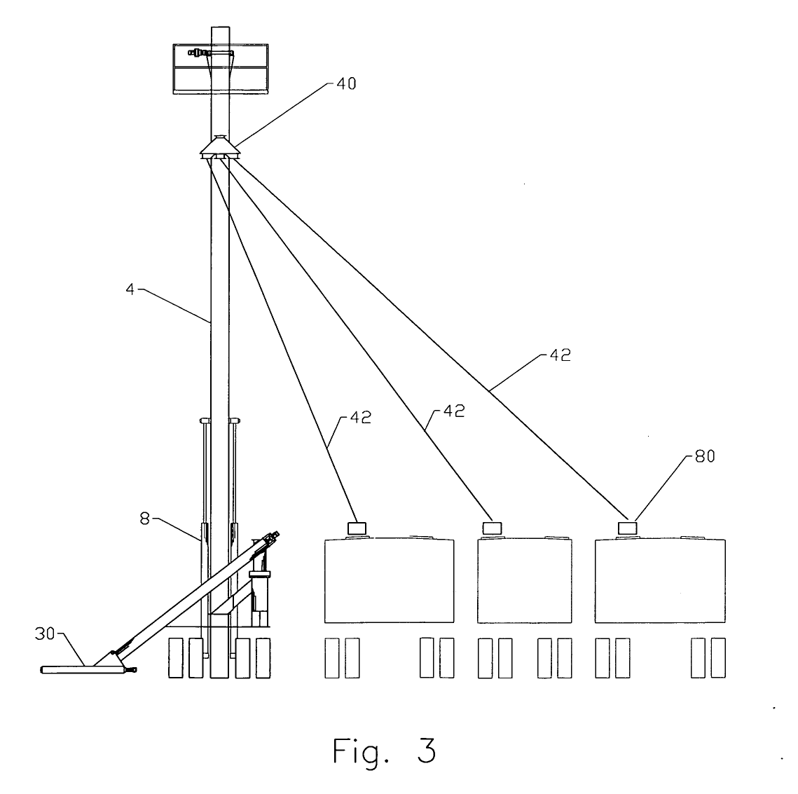

A further embodiment of the present invention is that upon being elevated to the top of vertical conveyance (4), material is discharged through a single outlet or multi-port distributor (40) as shown in FIGS. 2 and 3 into spouting (42) (FIG. 3) which conveys material to the desired point by gravity. Spouting may be metal or plastic or other variations of same, or may be flexible and/or hose. Distributor (40) allows the vertical conveyance (4) to put material into multiple locations rather than a single point. The distributor can be either manually or remotely operated. The distributor makes it possible for the invention to be erected in numerous positions on work sites, increasing its flexibility greatly.

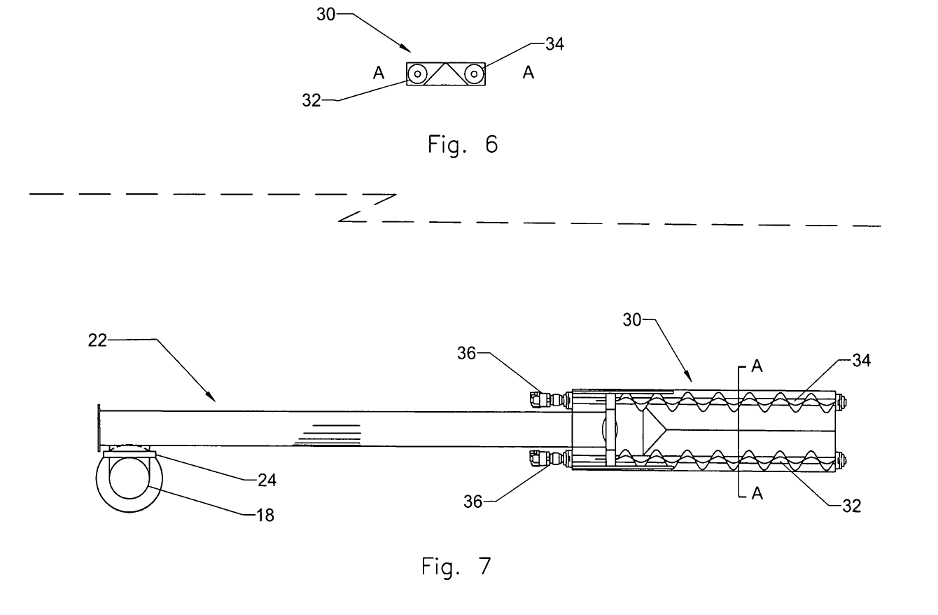

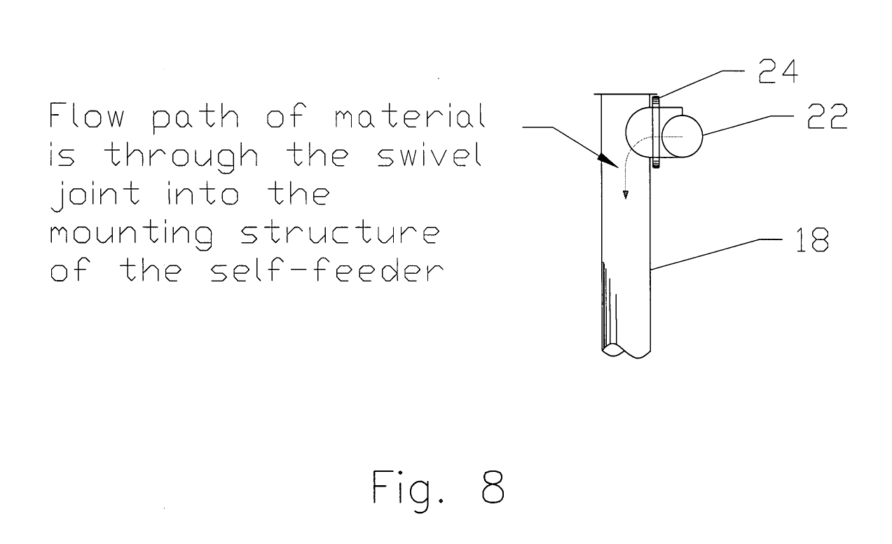

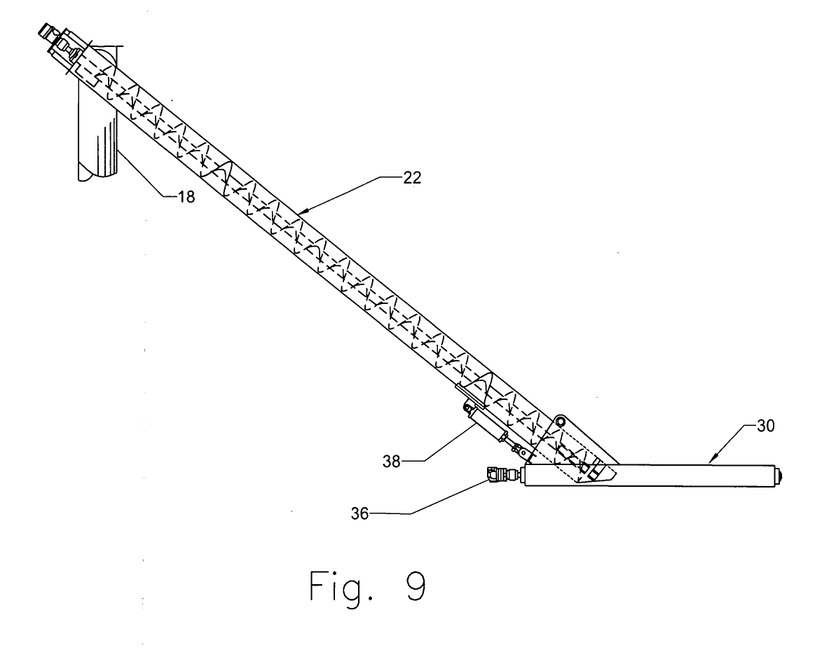

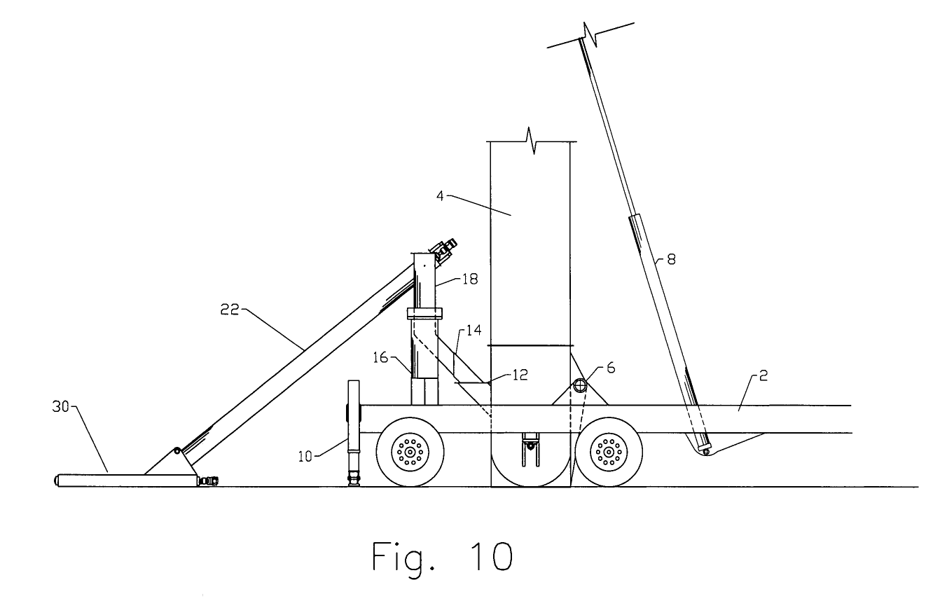

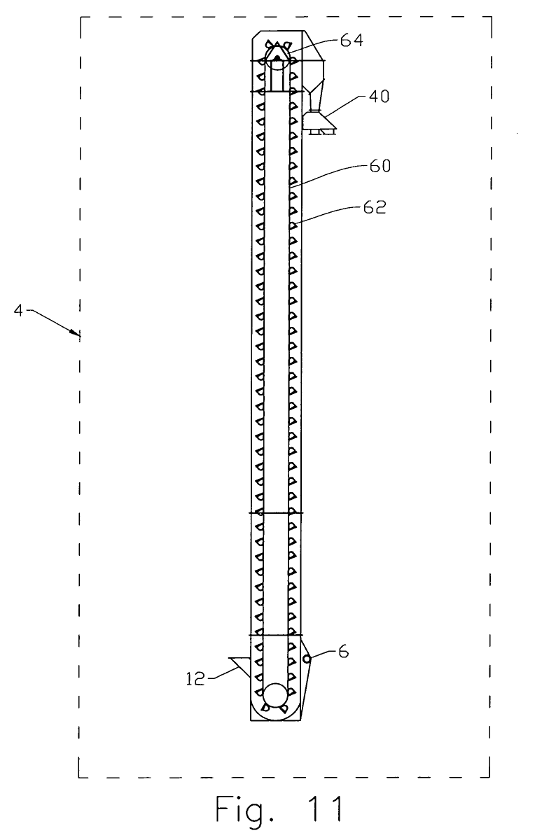

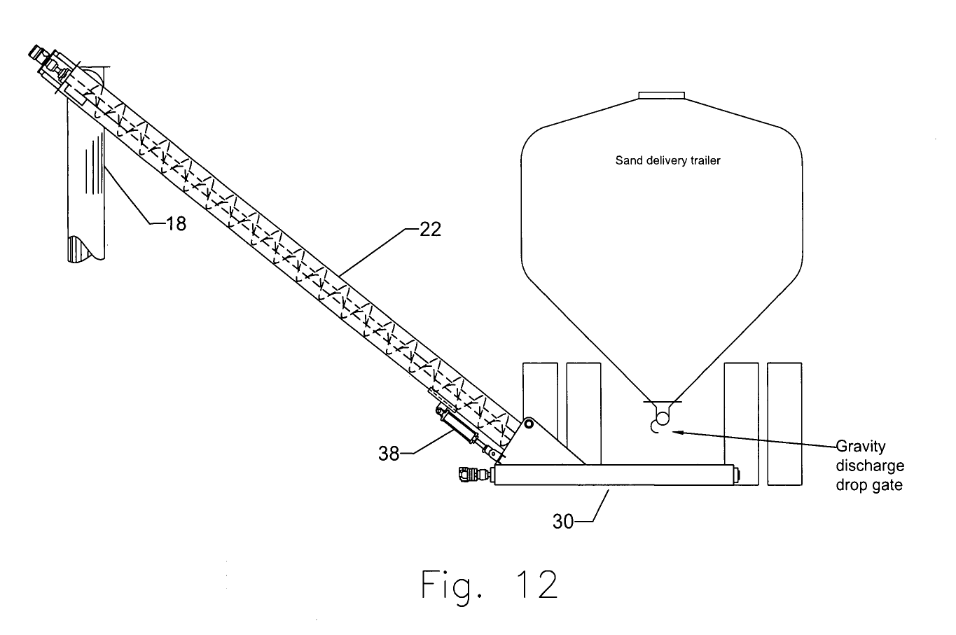

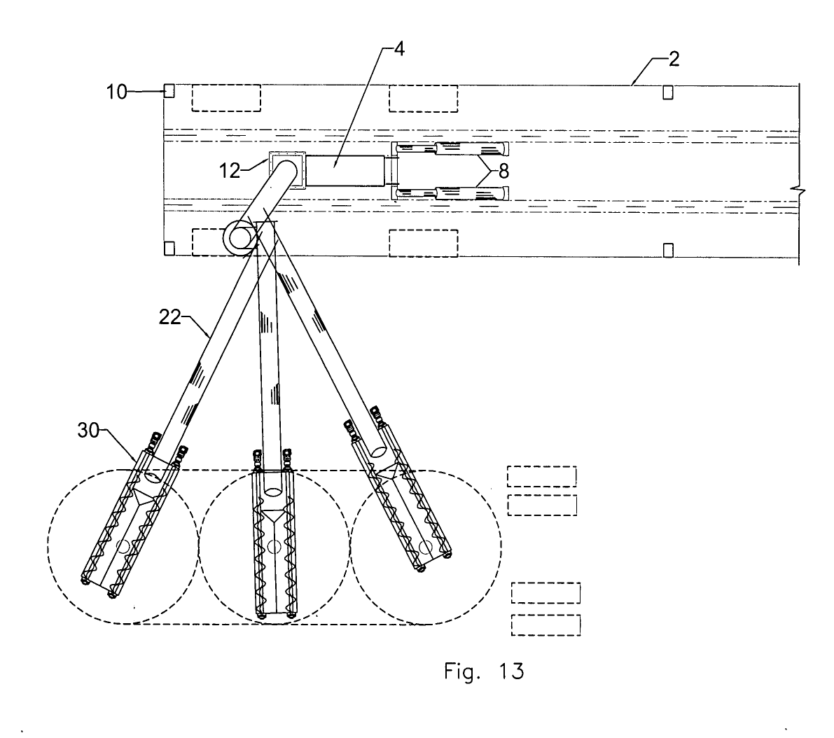

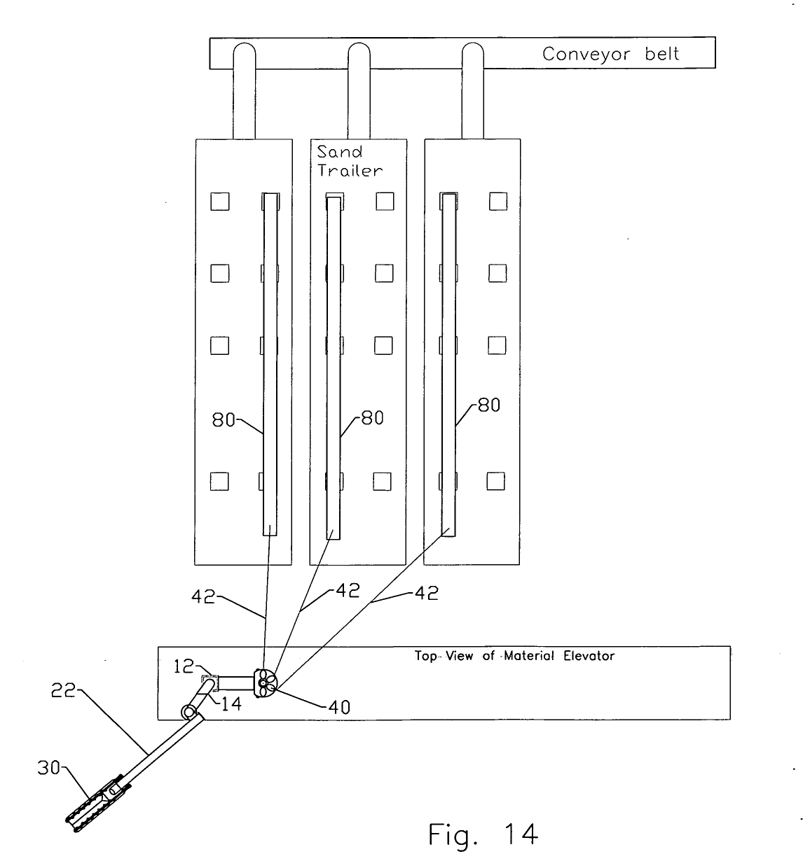

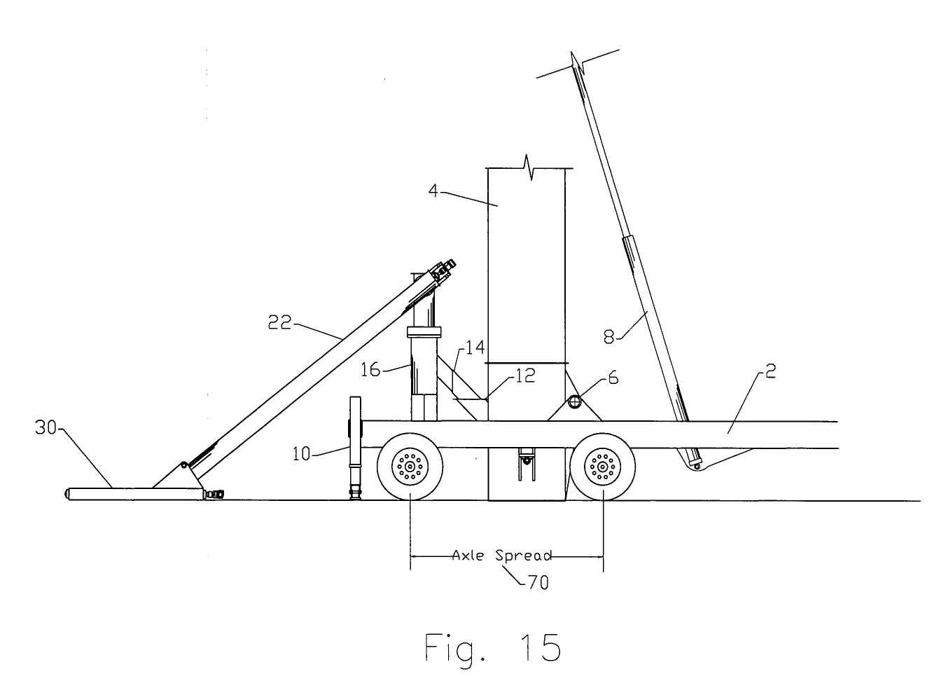

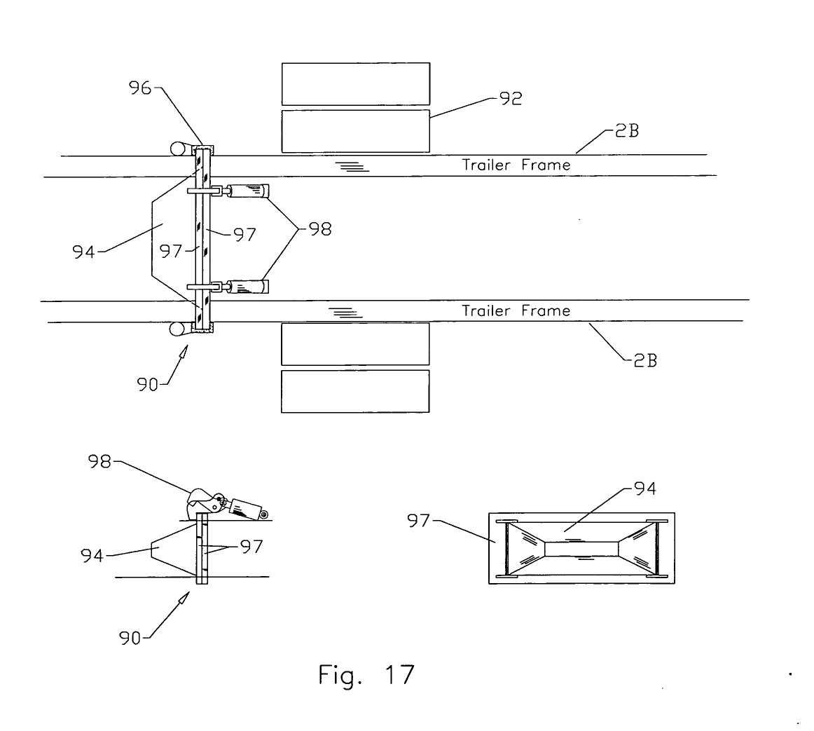

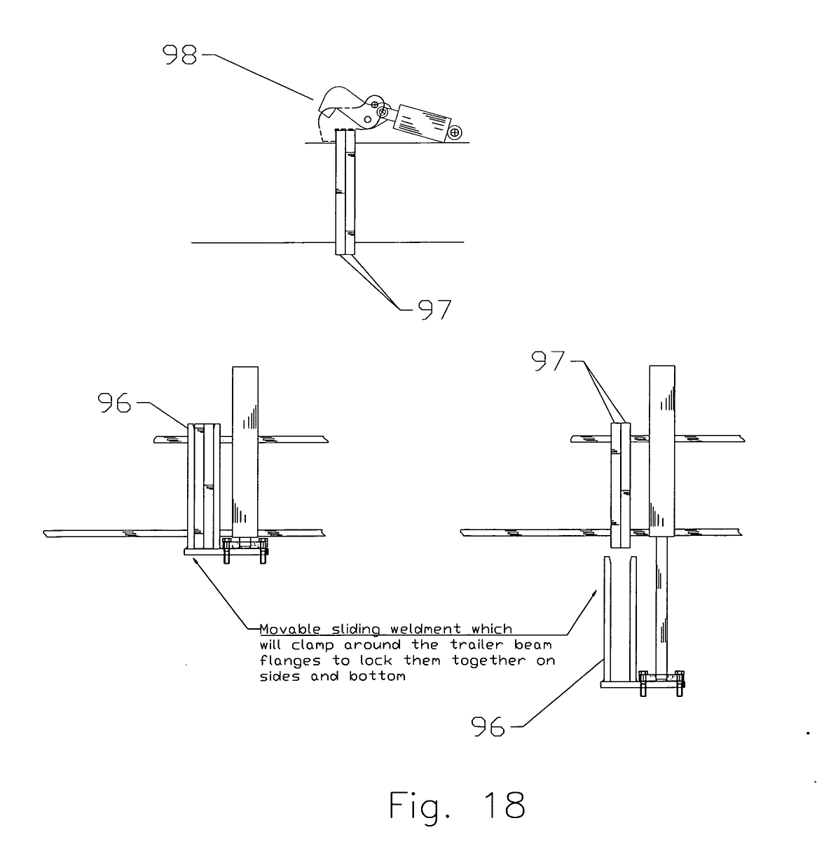

A further embodiment of the invention is the vertical conveyance bucket elevator (4) shown in FIG. 11. The bucket elevator (4) shown in FIG. 11 utilizes a belt (60) onto which are attached material-carrying buckets (62). Chain is another optional method for bucket attachment and conveyance. The belt with buckets continuously rotates around a head pulley (64) at the top of the elevator (4), and around a tail pulley (66) at the bottom of the elevator. As the belt rotates around pulleys (64, 66), material being conveyed is fed from the feed inlet hopper (12) into the buckets (62), which convey it to the top of the elevator (4). At the top of the elevator (4), the material is slung via centrifugal force or via gravity falls to the elevator discharge, where the material falls into the distributor (40) and is sent to the desired location through spouting (42). The vertical conveyance (4) may optionally be built with a continuous belt which has cups or other protuberances molded into/onto or otherwise attached to the belt carcass, and runs in an enclosure which more closely surrounds the belt than a standard bucket elevator design (as shown in FIGS. 1-20) with open area between the belts or with twin legs.

A further embodiment of this invention is that, depending on the end use of the material being fed by vertical conveyance (4), it may also be necessary to convey the material that is elevated and delivered. Drag conveyors, belt conveyors, auger screws, and other structure as known in the art and indicated generally in the drawings at reference numeral (80) may be used to move the material horizontally as needed. These secondary conveyors (80) are fed from the discharge distributor (40) via the spouting/pipe/hose (42). An example is distribution of sand to bins in a frac sand trailer—these trailers are long and low to the ground and need to have sand distributed into multiple compartments along their full length rather than from just a single point where the sand drops.

A further embodiment of this invention is that since there are times when the mobile material elevator of the present invention may be used on a working site with limited area, the trailer (2) is optionally provided with a disconnect (90) which allows the rear part (2A) of trailer (2) to uncouple from the forward part (2B) of trailer (2), the forward part (2B) being attached to the pulling truck (200), allowing the uncoupled forward part (2B) and truck (200) to be removed from the working site (FIG. 16). The material conveying portions of the invention are supported by the stabilizers (10) on rear part (2A) and remain stationary once erected at the working site until the rear part 2A is re-coupled to the forward part (2B) of transporting trailer (2) and moved to another location after lowering bucket elevator (4) to the second, transport position. The forward part 2B of trailer (2) is provided with a liftable axle (92) which is normally raised and does not contact the ground, but which is lowered to support the forward part 2B of trailer (2) when decoupling is desired. Lift axle (92) allows trailer part (2B) to be moved off location as though it were a normal trailer, with no additional equipment needed to effect its movement beyond its attached truck. In the embodiment shown, the trailer disconnect utilizes a frame-wide tapered guide pin (94) to aid in alignment when the trailer parts (2A, 2B) are connected back together for transport. Additionally, the disconnect uses a clamp (96) which slides over flanges (97) which are part of each trailer part (2A, 2B) to connect the trailer together, said trailer parts (2A, 2B) being further locked with a cam-over lock clamp (98) holding the flanges together on the fourth side of the clamp system as the slide clamp encompasses three sides of the mating flanges. Alternatively, bolt-together flanges may be utilized for this purpose, but may take considerably longer to connect.

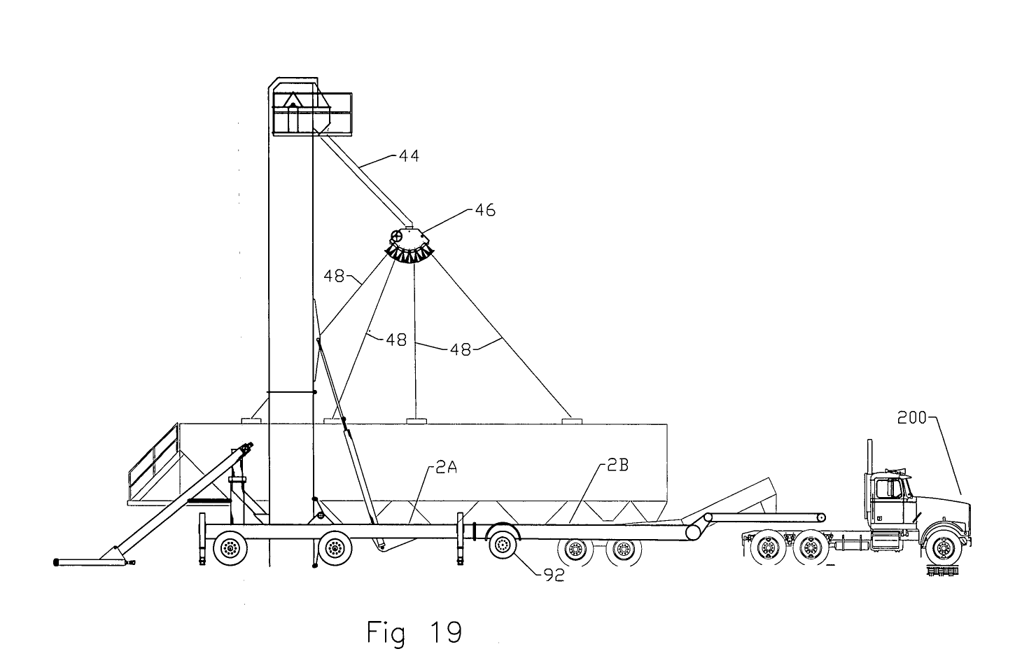

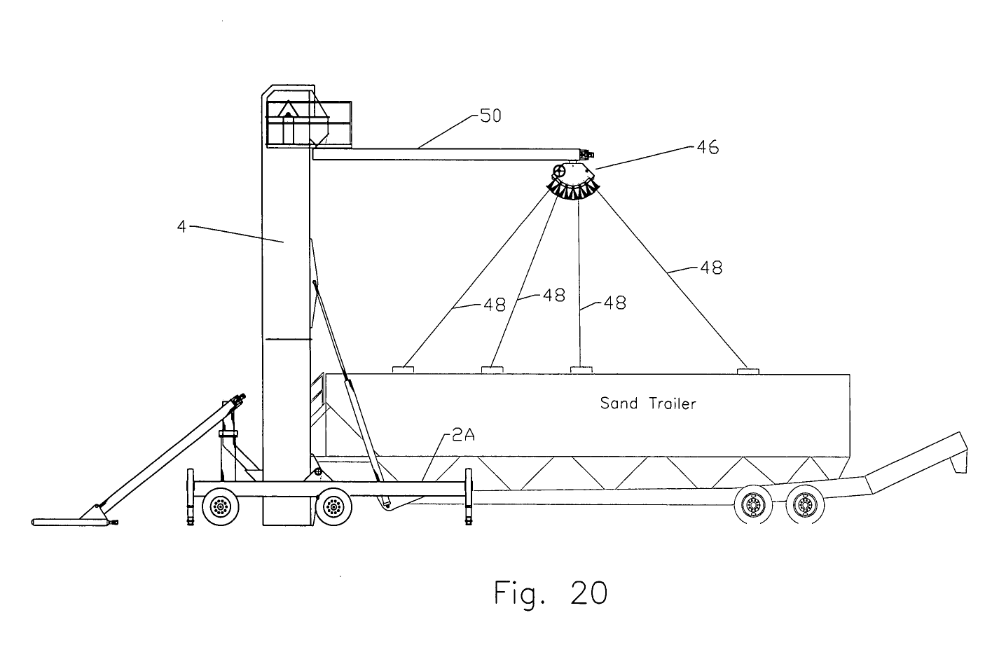

A further embodiment of this invention shown in FIGS. 19 and 20 is a variation of the distribution of material from the vertical conveyance (4) which, instead of discharging to a spout (42) feeding a drag chain or auger or belt (80) to mechanically distribute the material horizontally to multiple receiving/end use locations, feeds instead a remote distributor (46) which gravity feeds all the receiving/use points of the material. Drop spouts/tubes (48) are erected to each of the receiving/use points from the distributor (46) rather than utilizing a single drop spout feeding the secondary conveyance (80) which feeds material to those points; other features of the invention remain as originally described. The remote distributor (46) is connected to the vertical conveyance (4) via drop spout (44) or feeding auger/belt/chain conveyor (50).

Those skilled in the art who have the benefit of this disclosure will also recognize that changes can be made to the component parts of the present invention without changing the manner in which those component parts function and/or interact to achieve their intended result. All such changes, and others that will be clear to those skilled in the art from this description of the preferred embodiment(s) of the invention, are intended to fall within the scope of the following, non-limiting claims.

What is claimed is:

1. A mobile, erectable vertical material conveyance mounted on a trailer comprising a frame, axles, and wheels, and further comprising:
an erectable vertical elevating conveyance mounted to the trailer and pivotable from a first generally vertical position for receiving material to be elevated to a second, horizontal position for transport;
instruments for detecting vertical inclination of the elevating conveyance, with controls operably connected to said elevating conveyance for maintaining said elevating conveyance in an essentially true vertical position;
a system for feeding material into the vertical elevating conveyance, said system being mounted to and an integral part of the trailer, having an inclined conveyance pivotally attached to a rotating tower assembly for horizontally rotating the inclined conveyance from a first transport position to a second material-receiving position; and
a flow path of the material to be vertically conveyed being up the inclined conveyance, into and through the rotatable tower, into the vertical conveyance, and up the vertical conveyance to be discharged at height to desired distribution.

2. The mobile, erectable vertical conveyance of claim 1 further comprising a vertical conveyance feeder system which comprises a material-receiving feeder pan which fits under a truck, railcar, or other transport and which is low profile and is hydraulically positioned to sit on the ground in a manner in which material can be fed into it; which further comprises an inclined auger or other conveyance which raises the material from the ground feeder pan to adequate height to feed into the vertical conveyance; which further comprises a turret assembly which is hydraulically rotatable and to which the inclined conveyance/pan feeder are attached to, and which rotates about its center axis allowing positioning of the feeder pan in a horizontal arc from its transport position to allow unloading from material transport in various positions.

3. The mobile, erectable vertical conveyance of claim 1 further comprising a flow path from the inclined feeder conveyance which has material flowing from the inclined conveyance through a swivel joint and into the center of the rotating turret which mounts the inclined conveyance/feeder pan; with the material flow further moving vertically down through the turret through the center of the turntable bearing/gear which is used to mount the upper rotating turret assembly to the mounting structure on the trailer, and further falling onto a chute which exits the side of the mounting structure and directs the material toward the vertical conveyance of the invention.

4. The mobile, erectable vertical conveyance of claim 1 further comprising an extendible chute which connects the self-feeder material path to the vertical conveyance when the unit is erected and ready to use, said chute retracting to allow vertical conveyance to fold down for over-road transport, and movement of chute may be manual, hydraulic, electrically effected.

5. The mobile, erectable vertical conveyance of claim 1 further comprising a hydraulic cylinder system which is used to raise the vertical conveyance for operation and retract the vertical conveyance for transport, the cylinders are attached to the trailer main frame and to the vertical conveyance in a manner providing stability to the vertical conveyance for its operation without additional support off the trailer being needed.

6. The mobile, erectable vertical conveyance of claim 1 further comprising a hydraulic stabilizer system with 4 jacks which is used to level the platform to assure true vertical orientation of the vertical conveyance, the stabilizers may be hydraulic cylinders, screw jacks, or other mechanisms not specifically listed and the stabilizer system is manually or automatically controlled to level position, instrumentation including visual indicators and automatic leveling using gyroscopic or other level&/or tilt sensors to control the stabilizers to ensure true level of the base trailer and true vertical erection of the vertical conveyance.

7. The mobile, erectable vertical conveyance of claim 1 further comprising an optionally-reducible-length trailer to allow erection of the invention in tight locations, the trailer disconnects ahead of the forward stabilizers; the detachable section of the trailer is unique in that the forward portion of the trailer to be moved away is mobile because a lift axle is installed on that portion of the trailer to keep the forward portion from dragging on the ground or requiring additional machinery to move the trailer and the lift axle is of common art from various manufacturers, but its use for the purpose of allowing shortening of the invention when it is in an operating location is unique.

8. The mobile, erectable vertical conveyance of claim 1 further comprising a vehicle axle configuration such that mounting of the vertical conveyance sets the vertical conveyance base on the ground between the rearmost and next axle forward resulting in good weight distribution and increasing transport safety as it allows the rearmost axle to provide underride protection if a vehicle were to run into the rear of the unit in an accident.

9. A trailer-mounted, erectable vertical conveyance comprising:
a self-loader mounted to the trailer comprising a feeder pan positionable under a source of material;
a rotatable tower mount assembly mounted to the trailer;
an erectable vertical conveyance pivotally mounted to the trailer;
an inclined conveyance providing a flow path for the material being moved from said self-loader up into the inside of said tower mount, through the interior of said tower mount, and into said vertical conveyance;
a distributor mounted to the discharge of said vertical conveyance for directing the material discharge to desired locations; and
a hydraulic system for providing power to position and power said vertical conveyance and to position and power said self-loader.

10. The trailer-mounted material conveyance of claim 9 wherein said vertical conveyance is selectively positionable in first, upright for elevating material passing through the flow path and a second position in which said vertical conveyance is lowered and stowed on said trailer for over-the-road transport.

11. The trailer-mounted material conveyance of claim 9 additionally comprising a feeder pan assembly for conveying material to said inclined conveyance.

12. The trailer-mounted material conveyance of claim 9 additionally comprising a swivel joint in the flow path between said inclined conveyance and said tower mount.

13. The trailer-mounted material conveyance of claim 9 wherein said self-loader and said tower mount are selectively positionable in a first position for over-the-road transport and a second position for conveying material.

14. A mobile, erectable vertical conveyance comprising:
a vertical bucket elevator pivotally mounted to the trailer frame;
a hydraulic cylinder lift system used to raise the elevator to vertical and lower it to a road-transportable height;
stabilizers which level the unit for assuring true vertical positioning of the elevator;
a trailer mounted self-feeder assembly comprising an inclined conveyance and a feeder pan for feeding the inclined conveyance;
a rotatable tower mount assembly to which the self-feeder assembly is attached;
a flow path for material being moved from the top of the inclined conveyance, into the inside of the tower mount assembly, through the interior of the tower mount;
an extendible chute which retracts when the elevator is in second transport position and extends to receive material from the interior of the tower mount when the elevator is in the first operating position;
a swivel joint between the inclined conveyance and tower assembly through which the material passes;
hydraulic cylinders which function the vertical movement of the inclined auger and the under-transport feeder;
a rotating mechanism which causes the self-feeder assembly to rotate to operating positions and to stow the assembly for transport;
a distributor mounted to the discharge of the bucket elevator which directs the material discharge into selected spouts which in turn direct the material to desired locations;
a hydraulic system to provide power to position the elevator, power the elevator, function the self-feeder assembly positioning system, power the self-feeder, function the leveling system, and provide power for any other functions which may be required;
the trailer being provided with racks and holders to transport the spouting/pipes/hoses that convey the material being elevated to a final disposition point; and
drag conveyors/belts/augers for further distributing material which has been elevated to final disposition point.

15. A trailer-mounted, erectable vertical material conveyance comprising:
a tower mount mounted to the trailer;
an inclined conveyor mounted to said tower mount providing a flow path for material to be elevated up into said tower mount;
an erectable, elongate elevating conveyance mounted to the trailer and pivotable between a generally horizontal position for moving the trailer to a generally vertical position for receiving material from said tower mount;
sensors for monitoring and controls operably connected to said elevating conveyance for maintaining said elevating conveyance in the generally vertical position; and
a discharge at the top of said elevating conveyance for directing elevated material to one or more desired locations.

16. The vertical material conveyance of claim 15 additionally comprising a feeder pan mounted on the end of said inclined conveyor opposite said tower mount for receiving the material to be elevated and directing material onto said inclined conveyor.

17. The vertical conveyance of claim 16 wherein said tower mount is pivotally mounted to the trailer.

18. The vertical conveyance of claim 15 additionally comprising an extendible, positionable chute for feeding material from said inclined conveyance to said elevating conveyance.

19. The vertical material conveyance of claim 15 wherein said elevating conveyance is mounted between the axles of the trailer.

20. A mobile, erectable vertical material conveyance mounted on a trailer comprising:
a feeder pan movably mounted to the trailer and positionable under a source of material;
a rotatable tower mount assembly mounted to the trailer;
an inclined conveyor providing a flow path for the material being moved from said feeder pan up into said tower mount;
an erectable elevating conveyance mounted to the trailer and pivotable from a generally horizontal position for moving the trailer to a generally vertical position for elevating material; and
a discharge from said elevating conveyance for directing the elevated material to a desired location.

21. The vertical material conveyance of claim 20 additionally comprising means in said feeder pan for conveying material to said inclined conveyor.

22. The vertical material conveyance of claim 20 additionally comprising a swivel joint in the flow path between said inclined conveyor and said tower mount.

23. The vertical material conveyance of claim 20 wherein said elevating conveyance is mounted between the axles of the trailer.

24. A mobile, erectable vertical material conveyance mounted on a trailer, the trailer comprising a frame, axles, and wheels, comprising:
a vertical conveyance pivotally mounted to the trailer frame;
a lift system for selectively raising said conveyance to a first generally vertical position from a second, road-transportable position;
stabilizers for leveling and maintaining upright positioning of said vertical conveyance when in said first vertical position;
a self-feeder comprising an inclined conveyor pivotally mounted to the trailer and a feeder pan for feeding the inclined conveyor;
a rotatable tower mount into which the inclined conveyor feeds providing a flow path from the top of the inclined conveyor, into and through the rotatable tower mount, to a chute feeding into the vertical conveyance;
a distributor mounted to the discharge of the vertical conveyance; and
a hydraulic system for positioning and powering the vertical conveyance, positioning and powering the self-feeder, and operating said stabilizers.

25. The vertical material conveyance of claim 24 additionally comprising a swivel joint between said inclined conveyor and said tower mount.

26. The vertical material conveyance of claim 24 wherein the trailer to which said vertical conveyance is mounted is provided with racks and holders to transport one or more of spouting, pipes, and hoses for connecting to said distributor.

27. The vertical conveyance of claim 26 wherein the spouting, pipes, and hoses are selectively positionable proximate one or more of drag conveyors, belts, or auger.

28. A trailer-mounted, erectable vertical material conveyance comprising:
a rotatable tower mount assembly mounted to the trailer;
an inclined conveyance mounted to the trailer providing a flow path for material to be elevated up said inclined conveyance and into said tower mount;
an elevating conveyance mounted to the trailer and pivotable to a first generally vertical position for receiving material from said tower mount and elevating the material to a second generally horizontal position for moving the trailer;
sensors for monitoring and controls operably connected to said elevating conveyance for maintaining said elevating conveyance in said first position; and
a discharge from said elevating conveyance for directing elevated material to one or more desired locations.

29. The material conveyance of claim 30 wherein said inclined conveyance is pivotally mounted to the trailer.

30. The material conveyance of claim 30 additionally comprising a feeder pan mounted to the end of said inclined conveyance for feeding material to said inclined conveyance.

31. A method of elevating material for distribution to a desired location comprising the steps of
feeding the material to be elevated to the bottom of an inclined conveyance;
discharging the material from the top of the inclined conveyance, the inclined conveyance being pivotally mounted for positioning the bottom of the inclined conveyance at the point at which the material to be elevated is loaded onto the inclined conveyor and defining a flow path for the material to be elevated from the bottom of the inclined conveyance;
directing material from the end of the flow path opposite the bottom of the inclined conveyance into a vertical conveyance for elevating the material while maintaining the vertical conveyance upright; and
distributing the material from the top of the vertical conveyance to a desired location.

32. The method of claim 30 additionally comprising stabilizing the vertical conveyance in the upright position.

33. A vehicle axle configuration such that mounting of the vertical conveyance sets the vertical conveyance base on the ground between the rearmost and next axle forward resulting in good weight distribution, the shortest overall length possible, and heightened transport safety as it allows the rearmost axle to provide underside protection if a vehicle were to run into the rear of the unit in an accident.

34. A reducible length trailer with the frame connection comprising mating flanges which are held together with a sliding sleeve encompassing the flanges on 3 sides and which has a pivoting clamp on the fourth side to secure the lock function of the connection.

35. The trailer of claim 34, the sliding sleeve clamp being hydraulically functioned to slide the sleeve into place, with a hydraulic pivoting clamp securing the flanges for transport.

36. The trailer of claim 35 wherein the sleeve, the clamp, or both the sleeve and the clamp, are manually operated.
